(19) United States
(12) Patent Application Publication
(10) Pub. No.: US 2007/0002681 A1
(43) Pub. Date: Jan. 4, 2007

(54) Mixing and deaeration of viscous materials

(75) Inventors: David P. Vanderbilt, Webster, NY (US); Bradley Adams, Newport Richey, FL (US); Karen L. Walker, Rochester, NY (US); Horngyih Huang, Penfield, NY (US); Dominic V. Ruscio, Webster, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/169,446

(22) Filed: Jun. 29, 2005

(51) Int. Cl. B01F 9/02

(52) U.S. Cl. 366/217

(57) ABSTRACT

A method of producing and simultaneously deaerating a mixture comprises providing, in a container, components of the mixture; and subjecting the container to a rotational motion about a first axis in a first direction while rotating the container about a second axis in a second direction to effect a mixing and a substantially simultaneous deaeration.

### BACKGROUND OF THE INVENTION

The present invention relates to mixing and deaeration of viscous materials. In particular, the present invention relates to a method of rapidly mixing and deaeration of viscous materials.

Producing uniform mixtures is pervasively required in the chemical and pharmaceutical industries. Such mixtures often comprise thermally labile components that are brought together only shortly before a mixture is used. Therefore, it is desirable to minimize the mixing and preparing time of thermally labile components and to maximize the work life of the resulting mixture. The term “work life” means the time between the completion of the preparation of the mixture and the time at which the mixture is changed to a degree that the mixture is no longer usable for the application.

Mixing of flowable materials, such as liquids, has conventionally been accomplished by rotating blades or vanes immersed in the materials. However, it is difficult to employ this method to mix highly viscous materials. Mixers for such materials require high-torque rotors and high input power. Even then, viscous materials still require long mixing times to ensure the production of uniform mixtures and materials at corners of the container still are not likely mixed well. Mixing by stirring at high speeds also introduces a large amount of air into the resulting mixture, which must be deaerated before use. Deaeration of highly viscous mixtures is time consuming, and for thermally labile materials reduces their work lives.

Therefore, there is a continued need to provide methods for preparing mixtures of viscous materials, which methods require short preparation times and produce uniform mixtures. It is also very desirable to provide such methods for preparing mixtures of thermally labile, highly viscous materials.

### SUMMARY OF THE INVENTION

In general, the present invention provides a method for producing mixtures of viscous materials.

In another aspect, a method of the present invention requires a shorter time for preparing such a mixture than conventional mixing methods and provides a longer work life for such a mixture.

In another aspect, the present invention provides a method for producing substantially uniform mixtures of polymerizable components.

In still another aspect, a method of the present invention comprises providing, in a container, components of the mixture; and subjecting the container to a rotational motion about a first axis in a first direction while rotating the container about a second axis in a second direction to effect a substantially simultaneous mixing and deaeration.

In yet another aspect, the second axis is the center axis of the container.

In one embodiment, the container is disposed at a distance from the first axis, and the second axis forms an angle with the first axis.

Other features and advantages of the present invention will become apparent from the following detailed description and claims.

### BRIEF DESCRIPTION OF THE DRAWINGS

FIG. 1 is a schematic diagram of an apparatus for carrying out a method of mixing of the present invention.

FIG. 2 shows viscosity as function of time at room temperature of two lots prepared by a method of the present invention and two lots prepared by the stirring rod method.

### DETAILED DESCRIPTION OF THE INVENTION

In general, the present invention provides a method for producing mixtures of viscous materials. The term “viscous,” as used herein, means having a viscosity higher than that of water at the same temperature.

In one aspect, the present invention provides a method for producing mixtures of thermally labile, viscous materials.

In another aspect, a method of the present invention requires a shorter time for preparing such a mixture than a conventional mixing method that uses rotating blades, but produces a mixture having substantially the same or better uniformity and longer work life. The method of the present invention is advantageously applicable to viscous, thermally labile materials that would not tolerate a long preparation time because of rapid change in their properties at ambient or elevated temperatures.

A method of the present invention minimizes the time for preparing a mixture by preventing or minimizing an amount of air introduced into the mixture while it is prepared, and/or by simultaneously effecting a deaeration of the mixture.

In one embodiment, a method of the present invention comprises providing, in a container, components of the mixture; and subjecting the container to a rotational motion about a first axis in a first direction while rotating the container about a second axis in a second direction.

In one aspect, at least one component of the mixture is provided at a temperature lower than the mixing temperature. Alternatively, all of the components of the mixture are provided at a temperature lower than the mixing temperature. The starting temperature of one or more components of the mixture can be a temperature chosen such that the temperature of the mixture at the completion of the mixing is about room temperature.

In yet another aspect, the temperature at the end of the mixing is less than or equal to about 35° C.; preferably, less than or equal to about 30° C. Such a starting subambient temperature may be estimated from the knowledge of the desired end temperature, the amount of input power, and the heat capacities of the various components of the mixture. The component provided at subambient temperature can be cooled for a period of time sufficient to achieve the desired subambient temperature.

In another aspect, the rotational speed about the first and second axes is greater than about 500 revolutions per minute (“rpm”), preferably greater than about 1000 rpm, more preferably greater than about 2000 rpm. In another aspect, the rotational speed is in the range from about 2500 rpm to about 5000 rpm.

In one embodiment, the second axis is the center axis of the container. In another embodiment, the container is located at a distance from the first axis, and the second axis forms an angle with the first axis. In still another embodiment, the container is fixed to a support that is rotated about the first axis.

In one aspect, the second direction can be the same as or different than the first direction.

The components of the mixture can be reactants participating in a reaction. Alternatively, one of the components can be a catalyst that initiates or accelerates a reaction of one or more other components of the mixture.

In another embodiment, the components are polymerizable monomers or prepolymers that react when brought together to produce a polymer. A component of the mixture can be a catalyst for the polymerization reaction, such as a Pt organometallic complex for the hydrosilylation reaction, or acid or base catalysts for ring opening polymerization.

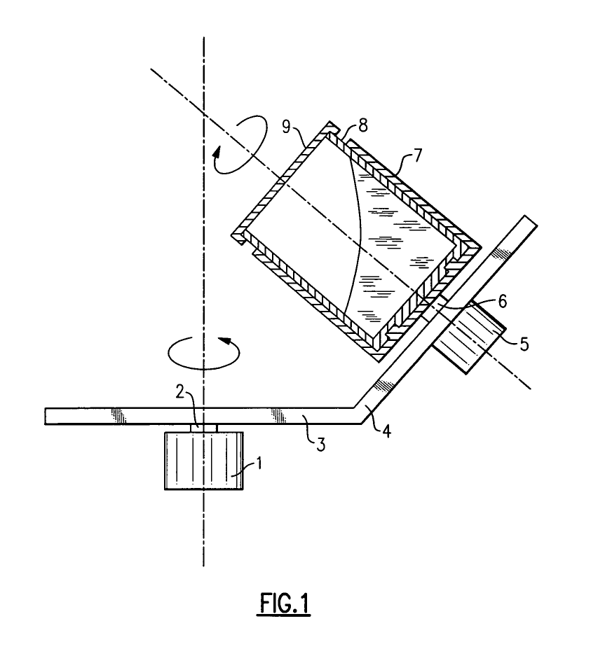

FIG. 1 is a schematic diagram showing essential elements of an embodiment of an apparatus for carrying out a method of mixing of the present invention. It should be understood that a method of the present invention is not limited by the following description of this apparatus. A main rotary shaft 2 is rotatably driven by a drive unit 1. Fixedly mounted on an upper end portion of the main drive shaft 2 is a rotary arm 3 which is provided with a raised oblique or inclined portion 4 in its distal end. A rotary drive mechanism 5 is provided for rotatably driving a rotary shaft 6 of the container 8. Container 8 is provided with a lid 8A for securing materials contained therein. Container 8 is removably secured in a container holder 7, which is fixed to oblique or inclined portion 4. In one embodiment, rotary drive mechanism 5 is fixedly mounted on a lower surface of the raised oblique portion 4 of the arm 3. A suitable transmission (not shown) constructed of gears and/or belts and pulleys for transmitting torque from main rotary shaft 2 of arm 3 to rotary drive mechanism 5 of container 8 may be interposed between rotary shaft 6 of container 8 and rotary drive mechanism 5. This arrangement of rotary drive mechanism 5 allows the rotation of container 8 on its own rotary shaft 6 to be coupled to the rotational motion of arm 3.

Alternatively, rotary drive mechanism 5 can be independent from drive unit 1 of main drive shaft 2, allowing container 8 to rotate at a different rotational speed and/or direction than that of arm 3. Thus, container 8 can rotate about rotary shaft 6 at rotational speed that is the same as or different than the speed of arm 3.

The material at any point inside container 8 is acted on by a combination of two centrifugal forces: one generated by the rotation of arm 3 and one by the rotation of container 8. Since container 8 is disposed at an angle with respect to the axis of rotation of shaft 2, material at a point in the half of container 8 that is further from shaft 2 experiences a net force that is directed upward, while material at a point in the half of container 8 that is closer to shaft 2 experiences a net force that is directed downward. As a consequence, such forces generate a constant mixing motion of all of the material inside container 8. Such an apparatus is commonly termed “dual axis centrifuge.” The constant lifting and falling motion also effects a compaction of the material, thereby, a simultaneous mixing and deaeration thereof.

Non-limiting examples of other apparatuses that are also suitable for carrying out a method of the present invention are disclosed in U.S. Pat. Nos. 4,235,553; 4,497,581; 4,728,197; 5,352,037; 5,551,779; 6,099,160; 6,709,151; 6,755,565; and U.S. patent Application 2002/0172091; all of which are incorporated herein by reference.

### EXAMPLE

Mixing, Deaeration, and Curing of Three Components of a Polymerizable Formulation

The first component consisted of a divinyl polysiloxane prepolymer, a siloxane resin having multiple vinyl functional groups, and a Pt organometallic complex catalyst. The second component consisted of a polymerizable benzotriazole UV blocker. The third component consisted of the divinyl polysiloxane prepolymer, a crosslinker, and a cyclic siloxane cure adjuster.

A predetermined amount of the premixed first and second components was weighed into a container having a volume of about 250 ml. The container and its contents were cooled overnight in a freezer to about −20° C. A predetermined amount of the third component, which was kept at room temperature, was added to the container at room temperature the next day. The container was installed in a FlackTek SpeedMixer™ DAC 400 FVZ (FackTek Inc., Landrum, S.C.), which is a dual axis centrifuge of the type described above. The contents were mixed at a speed of 2700 rpm, an acceleration factor of 500, and a total mixing time of 55 seconds. The container and the rotating arm on which it was disposed were rotated in opposite directions. The temperature of the contents at the end of mixing was 28.4° C. It was observed that the mixture required 20-30 minutes to degas. It is believed that the material in the container was compacted during mixing because of a downward motion generated in the container.

The same three components (all kept at room temperature prior to mixing) also were mixed in a 600-ml glass beaker equipped with a Teflon™-coated stirring rod having attached blades for 10 minutes. This mixing time had been established as adequate to produce a mixture suitable for the production of particular intraocular lenses from these materials. This method of mixing introduced much air into the mixture, which required between 1.5 and 3 hours to degas completely. Degassing of a mixture was observed while subjecting the mixture to a vacuum. Degassing was deemed to be complete when gas bubbles were no longer observed. Since less degas time was required with dual axis centrifuge mixing, more time was available to work with the mixture. Thus, if the mixture is used immediately after mixing, the work life of a mixture prepared by a method of the present invention can be as much as 2 hours 40 minutes longer than that prepared by the stirring rod method.

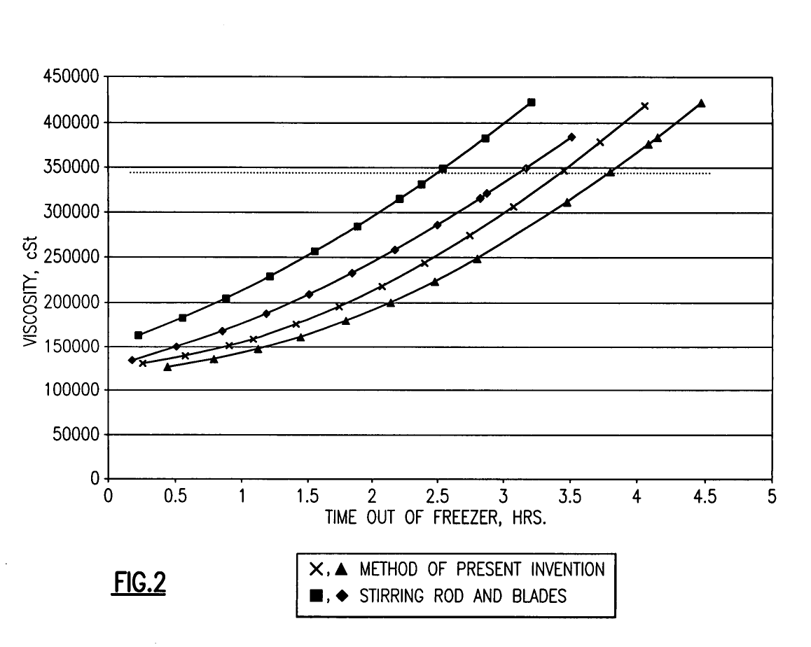

Mixtures produced in both methods were stored at −10° C. for one day. The mixtures were then allowed to stand at room temperature, and their viscosities were measured with increasing time at room temperature to calculate available work lives of the mixtures. The components slowly reacted together as the mixture temperature slowly rose. When the viscosity reached about 350,000 cSt (centistokes or mm²/s), the mixture was deemed to be unworkable. The results of the viscosity measurements for two lots using the method of the present invention and two other lots using the stirring rod method are shown in FIG. 2. The method of the present invention provides work life of about 0.5-1.5 hour longer than the stirring rod method, after the mixtures were stored for one day. Thus, with the shorter degassing time, a mixture prepared by a method of the present invention can have a work life that is up to 4 hours longer.

A mixing method of the present invention is advantageously used to prepare polymerizable compositions for the manufacture of ophthalmic devices, such as intraocular lenses and contact lenses. For example, a mixture produced by a mixing method of the present invention can be further formed into these ophthalmic devices by molding and curing the mixture. Alternatively, the mixture can be cured to form solid articles, which are then machined and/or lathed into the final ophthalmic devices.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A method for producing a mixture, said method comprising:
providing, in a container, components of said mixture; and
subjecting said container to a rotational motion about a first axis in a first direction while rotating said container about a second axis in a second direction to effect a mixing of said components and a substantially simultaneous deaeration of said mixture.

2. The method of claim 1, wherein at least one component of said mixture is provided at a first temperature below ambient temperature.

3. The method of claim 1, wherein a temperature of the mixture at the completion of said mixing is about room temperature.

4. The method of claim 1, wherein a temperature of the mixture at the completion of said mixing is less than or equal to about 35° C.

5. The method of claim 1, wherein a temperature of the mixture at the completion of said mixing is less than or equal to about 30° C.

6. The method of claim 1, wherein said container is located at a distance from said first axis.

7. The method of claim 1, wherein said second axis is a center axis of said container, and said second axis forms an angle with said first axis.

8. The method of claim 1, wherein said first direction is the same as said second direction.

9. The method of claim 1, wherein said first direction is opposite to said second direction.

10. The method of claim 1, wherein said container is fixed to a support that is rotated about said first axis.

11. The method of claim 1, wherein said container is rotated about said second axis at a rotational speed of said support.

12. The method of claim 1, wherein said container is rotated about said second axis at a rotational speed that is different than a rotational speed of said support.

13. The method of claim 1, wherein said components are polymerizable materials.

14. The method of claim 1, wherein said mixture is a polymerizable composition for a manufacture of ophthalmic devices.

15. The method of claim 1, wherein all components of said mixture are cooled, prior to said mixing, to a temperature lower than said temperature at the end of said mixing.

16. The method of claim 1, wherein all components of said mixture and said container are cooled to a temperature lower than said temperature at the end of said mixing.

17. A method of producing a mixture, said method comprising:
providing, in a container, components of said mixture; and
subjecting said container to a rotational motion about a first axis in a first direction while rotating said container about a second axis in a second direction to effect a mixing said components;
wherein said container is disposed at a distance from said first axis, said first and second axes form an angle, and at least one components of said mixture is provided at a first temperature that is chosen such that a temperature of said mixture at a completion of said mixing is less than about 30° C.

18. A method of producing a mixture, said method comprising:
providing, in a container, components of said mixture; and
subjecting said container to a rotational motion about a first axis in a first direction while rotating said container about a second axis in a second direction to effect a mixing said components;
wherein said container is disposed at a distance from said first axis, said first and second axis form an angle, a temperature of said mixture at a completion of said mixing is less than about 30° C., and the rotational speed of said first and second axes is in a range from about 2500 rpm and about 5000 rpm.
